(19) United States
(12) Patent Application Publication
(10) Pub. No.: US 2026/0036281 A1
(43) Pub. Date: Feb. 5, 2026

(54) WAVELENGTH CONVERSION DEVICE AND ILLUMINATION DEVICE

(71) Applicants: STANLEY ELECTRIC CO., LTD., Meguro-ku, Tokyo (JP); KYOTO UNIVERSITY, Kyoto-shi, Kyoto (JP)

(72) Inventors: Yosuke MAEMURA, Tokyo (JP); Ryosuke KAMAKURA, Tokyo (JP); Shunsuke MURAI, Kyoto (JP)

(73) Assignees: STANLEY ELECTRIC CO., LTD., Meguro-ku, Tokyo (JP); KYOTO UNIVERSITY, Kyoto-shi, Kyoto (JP)

(21) Appl. No.: 18/873,607

(22) PCT Filed: Jun. 7, 2023
(86) PCT No.: PCT/JP2023/021115

§ 371 Date: Oct. 20, 2025

(30) Foreign Application Priority Data
Jun. 20, 2022 (JP) 2022-098681

(51) Int. Cl. F21V 9/32; C09K 11/77; F21Y 115/10

(52) U.S. Cl. CPC F21V 9/32; C09K 11/7715; F21Y 2115/10

(57) ABSTRACT

A wavelength conversion device includes a phosphor member and a plurality of nanoantennas. The phosphor member has one surface on which an excitation light is incident, includes a phosphor excited by the excitation light to emit a fluorescence, and has an uneven structure on another surface in an opposite side of the one surface. The uneven structure includes a plurality of projecting portions each provided in one direction along the other surface at a pitch smaller than a peak wavelength of the fluorescence. The plurality of nanoantennas are provided at upper surfaces of the plurality of projecting portions and made of a metal material.

### TECHNICAL FIELD

The present invention relates to a wavelength conversion device and an illumination device.

### BACKGROUND ART

There has been disclosed an illumination device that narrows an angle of a light using a metal antenna made of nanosized metal particles (hereinafter referred to as a nanoantenna). For example, Patent Document 1 discloses an illumination device that includes a transparent substrate, a wavelength converter disposed on the transparent substrate, and a plurality of nanoantennas formed on the wavelength converter.

### PRIOR ART DOCUMENTS

### Patent Literature

Patent Document 1: JP-T-2014-508379

### DISCLOSURE OF THE INVENTION

### Problems to be Solved by the Invention

In the illumination device as disclosed in Patent Document 1, a component exceeding a critical angle of a fluorescence generated by excitation of a phosphor in the wavelength converter with an excitation light is totally reflected by an interface between the wavelength converter and air. At this time, there is a problem that a part of the totally reflected fluorescence is repeatedly multiply reflected inside the wavelength converter without being extracted outside, and then absorbed by the nanoantenna, thus reducing a light extraction efficiency of the entire illumination device.

The present invention is made in consideration of the above-described problem, and it is an object of the present invention to provide a wavelength conversion device and an illumination device capable of improving a light extraction efficiency while achieving a narrowed angle of a fluorescence with a nanoantenna.

### Solutions to the Problems

A wavelength conversion device according to the present invention includes a phosphor member and a plurality of nanoantennas. The phosphor member has one surface on which an excitation light is incident, includes a phosphor excited by the excitation light to emit a fluorescence, and has an uneven structure on another surface in an opposite side of the one surface. The uneven structure includes a plurality of projecting portions each provided in one direction along the other surface at a pitch smaller than a peak wavelength of the fluorescence. The plurality of nanoantennas are provided at upper surfaces of the plurality of projecting portions and made of a metal material.

### BRIEF DESCRIPTION OF THE DRAWINGS

FIG. 1 is a top view of a wavelength conversion device according to a first embodiment.

FIG. 2 is a cross-sectional view of the wavelength conversion device according to the first embodiment.

FIG. 3 is a graph illustrating a transmission intensity relative to an incidence angle in the wavelength conversion device according to the first embodiment.

FIG. 4 is a graph illustrating a transmission intensity relative to a depth of a recessed portion in the wavelength conversion device according to the first embodiment.

FIG. 5 is a graph illustrating the transmission intensity relative to the depth of the recessed portion in the wavelength conversion device according to the first embodiment.

FIG. 6 is a graph illustrating a penetration length of an evanescent light relative to the incidence angle in the wavelength conversion device according to the first embodiment.

FIG. 7 is a top view of the wavelength conversion device according to a modification of the first embodiment.

FIG. 8 is a cross-sectional view of a wavelength conversion device according to a second embodiment.

FIG. 9 is a cross-sectional view of an illumination device according to a third embodiment.

FIG. 10 is a cross-sectional view of a wavelength conversion device according to the third embodiment.

### DESCRIPTION OF PREFERRED EMBODIMENTS

The following specifically describes embodiments of the present invention with reference to the drawings. In the drawings, the same reference numerals are attached to the same components, and the explanation of the overlapping components will be omitted.

### First Embodiment

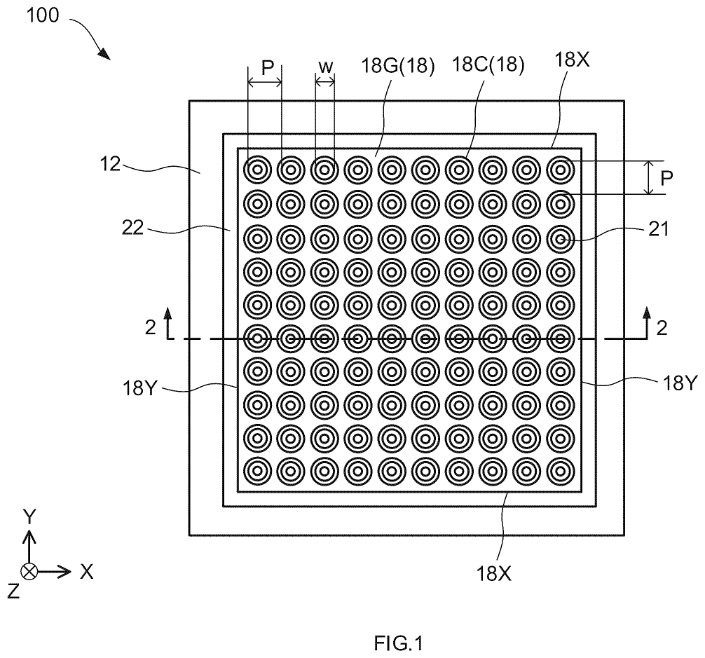

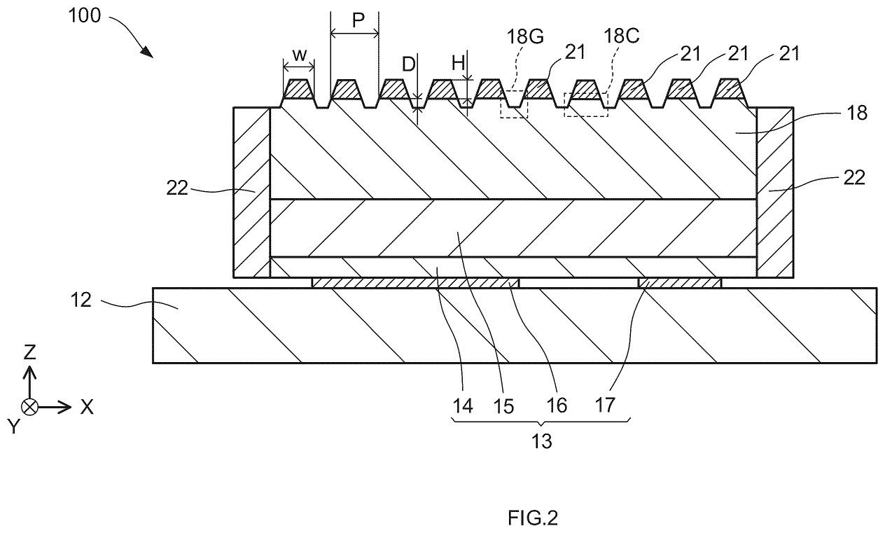

With reference to FIG. 1 and FIG. 2, a configuration of a wavelength conversion device 100 according to the first embodiment is described. FIG. 1 is a top view of the wavelength conversion device 100 according to the first embodiment. FIG. 2 is a cross-sectional view of the wavelength conversion device 100 along the line 2-2 illustrated in FIG. 1.

### [Mounting Substrate]

A mounting substrate 12 is an insulating flat plate-shaped substrate having a rectangular upper surface shape. The mounting substrate 12 is made of, for example, aluminum nitride (AlN), alumina (Al₂O₃), or the like. Hereinafter, for ease of explanation, X, Y, and Z-axes are defined by having a direction perpendicular to the upper surface of the mounting substrate 12 as a Z-axis and directions along mutually perpendicular respective two sides of the mounting substrate 12 as an X-axis and a Y-axis.

### [Light-Emitting Element]

A light-emitting element 13 is a light emission diode (LED) that is mounted on the upper surface of the mounting substrate 12 and has a rectangular upper surface shape. The light-emitting element 13 includes a semiconductor structure layer 14 with a light-emitting layer, a support substrate 15 disposed on an upper surface of the semiconductor structure layer 14, and a p-electrode 16 and an n-electrode 17 disposed on a lower surface of the semiconductor structure layer 14 and joined to the mounting substrate 12. That is, the light-emitting element 13 is flip-chip mounted to the mounting substrate 12.

The semiconductor structure layer 14 is a semiconductor stacked body including an n-type semiconductor layer, a light-emitting layer, and a p-type semiconductor layer (neither is illustrated) each containing gallium nitride (GaN) as a main material. When the light-emitting element 13 is driven, the light-emitting layer of the semiconductor structure layer 14 emits a blue light having a peak wavelength of 450 nm.

The support substrate 15 is a flat plate-shaped substrate having a rectangular upper surface shape. The support substrate 15 is made of a material, such as single crystal sapphire (Al₂O₃), having translucency to the blue light emitted from the semiconductor structure layer 14. The upper surface of the support substrate 15 is a light-emitting surface from which the light-emitting element 13 emits the blue light.

The p-electrode 16 is an electrode electrically connected to the p-type semiconductor layer of the semiconductor structure layer 14. The p-electrode 16 is joined to a p-side wiring (not illustrated) formed on the upper surface of the mounting substrate 12 via a conductive joining member (not illustrated).

The n-electrode 17 is an electrode electrically connected to the n-type semiconductor layer via a through electrode (not illustrated) that penetrates the light-emitting layer and the p-type semiconductor layer of the semiconductor structure layer 14 in an up-down direction and has a side surface covered with an insulator. In other words, the n-electrode 17 is electrically connected to only the n-type semiconductor layer and insulated from the light-emitting layer and the p-type semiconductor layer. The n-electrode 17 is joined to an n-side wiring (not illustrated) formed on the upper surface of the mounting substrate 12 via a conductive joining member (not illustrated).

As described above, the light-emitting element 13 has a structure that emits a blue light generated by applying a voltage to the p-electrode 16 and the n-electrode 17 via the mounting substrate 12 to cause a current flowing through the semiconductor structure layer 14 from the upper surface of the support substrate 15.

### [Phosphor Member]

A phosphor member 18 is a phosphor plate bonded to the upper surface of the light-emitting element 13, that is, the upper surface of the support substrate 15 via a translucent joining member (not illustrated), and the phosphor member 18 has a thickness of 50 to 250 μm and a rectangular upper surface shape. The phosphor member 18 has the same shape as the support substrate 15 of the light-emitting element 13 in top view.

The phosphor member 18 is made of a phosphor that is excited by the blue light emitted from the light-emitting element 13 to emit a yellow fluorescence. Specifically, the phosphor member 18 is, for example, a single-phase transparent ceramic phosphor plate made of yttrium aluminum garnet phosphor activated with cerium (Ce) (YAG:Ce).

When an excitation light emitted from the light-emitting surface of the light-emitting element 13 is incident on the phosphor member 18, a part of it directly passes through the phosphor member 18, and another part of it excites the phosphor to cause the excited phosphor to emit a yellow fluorescence. The yellow fluorescence emitted from the phosphor has a peak wavelength of 520 to 570 nm, and has a yellow emission spectrum with a broad peak of from 480 nm to 700 nm.

Therefore, the excitation light (blue light) that has passed through the phosphor member 18 without a contribution to the generation of the fluorescence and the fluorescence (yellow light) emitted from the phosphor are emitted from the upper surface of the phosphor member 18. Accordingly, a white light in which the blue light and the yellow fluorescence emitted from the upper surface of the phosphor member 18 are mixed is extracted from the wavelength conversion device 100.

In the following description, as illustrated in FIG. 1, a pair of sides extending in the X-direction in the drawing of the phosphor member 18 are defined as sides 18X, and a pair of sides extending in the Y-direction in the drawing of the phosphor member 18 are defined as sides 18Y.

The upper surface of the phosphor member 18 has an uneven structure including truncated circular cone-shaped projecting portions 18C arranged along each of the X-direction and the Y-direction at a pitch P in a matrix and recessed portions 18G formed between the projecting portions 18C in a square grid pattern.

The recessed portions 18G of the uneven structure have a structure in which a plurality of grooves arranged in a plurality of vertical and longitudinal rows are combined, and form a grid-like structure that individually divides the projecting portions 18C. The pitch P is a pitch smaller than a peak wavelength of the fluorescence emitted from the phosphor member 18. The pitch P is preferably 500 nm or less.

### [Nanoantenna]

Nanoantennas 21 are a plurality of circular truncated cone-shaped metal materials formed on respective upper surfaces of the projecting portions 18C in the uneven structure of the phosphor member 18. Since the nanoantennas 21 are formed on the respective upper surfaces of the projecting portions 18C arranged in a square grid pattern, consequently, the nanoantennas 21 are arranged in a square grid pattern at the pitch P in top view similarly to the projecting portions 18C.

Each of lower surfaces of the nanoantennas 21 has the same size as each of the upper surfaces of the projecting portions 18C of the phosphor member 18. In other words, the lower surface of the nanoantenna 21 and the upper surface of the projecting portion 18C of the phosphor member 18 have a mutually same diameter W, and the projecting portion 18C and the nanoantenna 21 formed on the upper surface of the projecting portion 18C are combined to form a circular truncated cone shape as a whole.

The nanoantennas 21 have a mutually same height H on the respective upper surfaces of the projecting portions 18C. Each of the nanoantennas 21 is configured by a material having a plasma frequency in a visible light region, such as Au (aurum), Ag (argentum), Cu (copper), Pt (platinum), Pd (palladium), Al (aluminum) and Ni (nickel), and an alloy or a stacked body containing them. Especially, each of the nanoantennas 21 is preferably configured by a metal with low absorption in the visible light region, such as aluminum (Al) and argentum (Ag).

The uneven structure of the phosphor member 18 and the arrangement aspect of the nanoantenna 21 of FIG. 1 and FIG. 2 are merely schematically illustrated for describing the uneven structure and the nanoantenna 21. Actually, the light-emitting element 13 is, for example, 1 mm square, and in this case, the numbers of the projecting portions 18C and the nanoantennas 21 to be formed are larger than those illustrated in FIG. 1 and FIG. 2.

Here, an effect of enhancing the fluorescence provided by the nanoantenna 21 is described.

When a fluorescence reaches the upper surface of the phosphor member 18 with an angle equal to or more than a critical angle, the fluorescence is totally reflected by the upper surface. When the total reflection occurs, an evanescent wave that penetrates from the upper surface of the phosphor member 18 to a low refractive index medium side is generated. The evanescent wave propagates along the upper surface of the phosphor member 18, in other words, along an interface between the phosphor member 18 and air.

When reaching the nanoantenna 21, the evanescent wave propagating along the upper surface of the phosphor member 18 is radiated in a form of a visible light having the same wavelength as the fluorescence in a direction that meets a diffraction condition determined based on the arrangement pitch of the nanoantenna 21. This phenomenon causes the fluorescence to be emitted in a narrow angle range meeting the diffraction condition, and encourages narrowing the angle of the fluorescence emitted from the upper surface of the phosphor member 18.

When the fluorescence emitted from the phosphor member 18 is irradiated on the nanoantenna 21, a localized surface plasmon resonance occurs on the surface of the nanoantenna 21, and an electric field strength at the proximity of the nanoantenna 21 increases. Then, in a group of the nanoantennas 21 arranged at the pitch P smaller than the peak wavelength of the fluorescence as described above, at a part close to an adjacent nanoantenna 21, in other words, a part facing an adjacent nanoantenna 21 of the surface of each nanoantenna 21, the electric field strength further increases.

Due to the highly localized plasmon resonance as a result of the enhanced electric field, the fluorescence is extremely amplified at the proximity of the nanoantenna 21, and the amplified fluorescence has a light distribution characteristic of narrow angle (low etendue). That is, the nanoantenna 21 has a function of enhancing the fluorescence emitted from the phosphor member 18 and narrowing an emission direction of the fluorescence.

### [Light Reflecting Member]

A light reflecting member 22 is a member with a light reflectivity continuously extending to cover respective outer surfaces of the semiconductor structure layer 14 and the support substrate 15 of the light-emitting element 13 and the phosphor member 18. The light reflecting member 22 is configured by a translucent resin containing light scattering particles, and for example, made of a resin material in which titanium oxide (TiO₂) particles are contained in a silicone resin.

The light reflecting member 22, for example, reflects the excitation light (blue light) emitted from the light-emitting element 13 and reached the outer surface upward. The light reflecting member 22, for example, reflects the fluorescence generated inside the phosphor member 18 and reached the outer surface upward.

As described above, the plurality of recesses and projections formed on the upper surface of the phosphor member 18 are arranged at the pitch P smaller than the peak wavelength of the fluorescence emitted from the phosphor member 18. In other words, the phosphor member 18 has an uneven structure including a plurality of projecting portions provided at a pitch smaller than the peak wavelength of the fluorescence at the upper surface.

According to the embodiment, since the pitch P in the uneven structure at the surface of the phosphor member 18 is smaller than the peak wavelength of the fluorescence, when the fluorescence reaches the uneven structure, the fluorescence behaves similarly to a case where a refractive index of a medium gradually changes in a height direction of the unevenness structure part, specifically a case where the refractive index changes to become low and approach a refractive index of air toward the upper side.

Therefore, the critical angle of the fluorescence to the interface between the phosphor member 18 and air at the upper surface of the phosphor member 18 is large compared with a case without the uneven structure, and the total reflection is less likely to occur. Accordingly, a component equal to or more than the critical angle of the fluorescence of the phosphor member 18 can be reduced, and a component totally reflected by the interface between the phosphor member 18 and air can be reduced.

Therefore, according to the embodiment, a proportion of the fluorescence extracted from each of the upper surfaces of the projecting portions 18C of the phosphor member 18 can be increased. That is, the light extraction efficiency can be improved while achieving the narrowed angle of the fluorescence with the nanoantenna 21.

### [Method for Producing Phosphor Member]

The following describes a method for producing the phosphor member 18 having the uneven structure and including the nanoantenna 21 formed on the upper surface of the projecting portion 18C of the uneven structure.

First, a metal film of Al or Ag as a base material of the nanoantenna 21 is formed on an upper surface of a flat plate-shaped base material to be the phosphor member 18 by an electron beam evaporation or a sputtering film formation (Step 1).

Next, a resist is applied over the metal film formed in Step 1, and a patterning is performed to form unevenness in a square grid pattern using a nano-imprint apparatus or an ion beam drawing apparatus (Step 2).

Next, by using the resist applied over the part to be the projecting portion of the unevenness patterned in Step 2 as an etching mask, a dry etching of the part to be the recessed portion is performed (Step 3). At this time, by performing the etching until a depth of the recessed portion becomes a depth D, the uneven structure including the recessed portion 18G having the depth D is obtained.

Finally, the etching mask (resist) of the part to be the projecting portion is removed by ashing (Step 4). Thus, the phosphor member 18 having the uneven structure on the upper surface and including the nanoantennas 21 formed on the respective upper surfaces of the projecting portions 18C of the uneven structure can be obtained.

When the uneven structure of the phosphor member 18 and the nanoantenna 21 are formed by the above-described etching, the type of etching gas can be appropriately selected corresponding to the etching target. For example, when the nanoantenna 21 made of Al is formed, the etching is performed using a chlorine (Cl₂) gas and an argon (Ar) gas. For example, when the uneven structure is formed on a phosphor plate made of a YAG:CEe phosphor, the etching is performed using a sulfur hexafluoride (SF₆) gas, a methane tetrafluoride (CF₄) gas, and the like.

### [Validations]

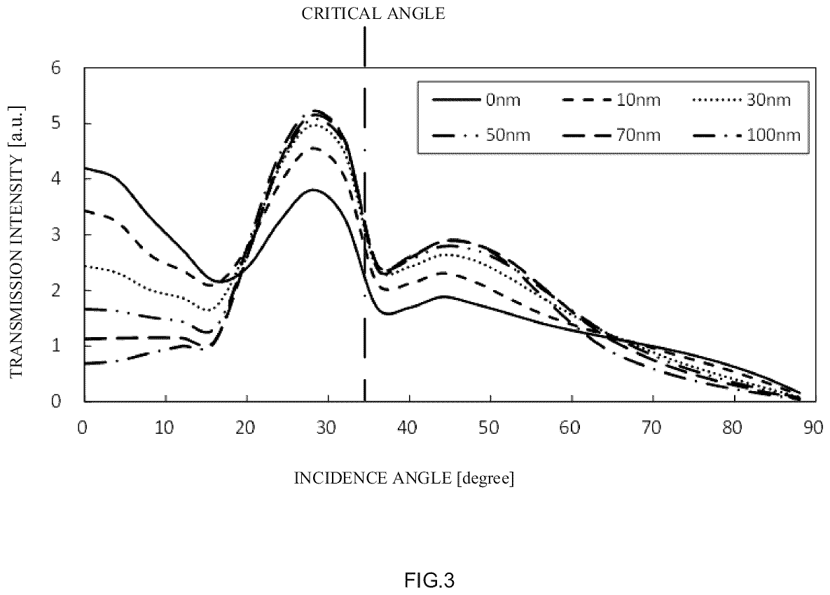

The following describes validations performed on the wavelength conversion device 100 of the present invention and validation results thereof with reference to FIG. 3 to FIG. 6. In the validation, the depth D of the recessed portion 18G in the uneven structure of the phosphor member 18 was mainly verified.

A model used in the validation is described. The phosphor member 18 is a YAG:Ce phosphor single-phase single-crystal ceramic plate, and the nanoantenna 21 is made of Al. In the uneven structure of the phosphor member 18, the above-described pitch P of unevenness is 350 nm, and the arrangement aspect is the square grid arrangement. The nanoantenna 21 has the height H of 150 nm, and the lower surface diameter W (diameter of the upper surface of the projecting portion 18C) of 200 nm. The incident light incident from the phosphor member 18 on the nanoantenna 21 has the wavelength of 550 nm (peak wavelength of yellow fluorescence).

FIG. 3 is a graph illustrating a result of a calculation of an intensity of a fluorescence extracted in air via the nanoantenna 21 (passing through the surface on which the nanoantenna 21 is formed) when the incidence angle of the fluorescence to the interface between the phosphor member 18 and air is changed using RCWA (Rigorous Coupled Wave Analysis) method.

FIG. 3 illustrates transmission intensities of the fluorescence when the depth D of the recessed portion 18G is 0 nm (without the uneven structure), 10 nm, 30 nm, 50 nm, 70 nm, and 100 nm. FIG. 3 also illustrates the critical angle of the incidence at the interface between the phosphor member 18 and air in a case without the nanoantenna and the uneven structure (a case of the depth D of 0 nm) with a double-dashed dotted line. In this embodiment, the critical angle is 34 degrees.

From FIG. 3, it is seen that when the incidence angle of the fluorescence is in a range of from 20° to 65°, the transmission intensity at the depth D of the recessed portion 18G of 10 nm, 30 nm, 50 nm, 70 nm, and 100 nm is high compared with the case without the recessed portion (D=0 nm). Especially, in the range of the fluorescence incidence angle of from 20° to the critical angle of the case without the nanoantenna and the uneven structure (double-dashed dotted line in the drawing), it is significantly indicated that the transmission intensity becomes high in the case of including the recessed portion 18G in the phosphor member 18 compared with the case without the recessed portion.

Further, it is seen that in the range of the fluorescence incidence angle of from 20° to 65°, the transmission intensity increases as the depth D of the recessed portion 18G increases. Thus, by providing a plurality of recesses and projections including the recessed portions 18G having the depth D at the phosphor member 18, the high light extraction efficiency can be provided in a wide range of the fluorescence incidence angle.

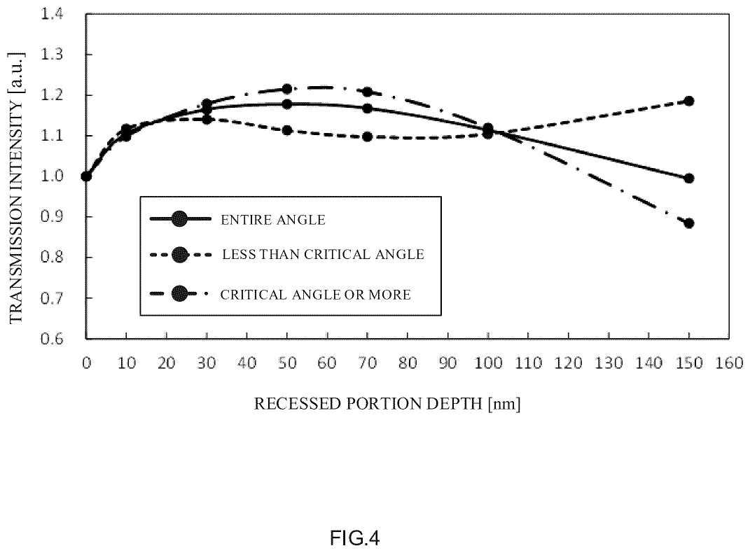

FIG. 4 is a graph illustrating a result of a calculation of the transmission intensity when the depth D of the recessed portion 18G is changed using the RCWA method. In FIG. 4, the transmission intensity was calculated in each of a case where the incidence angle of the fluorescence was the entire angle range, a case where the fluorescence incidence angle was up to less than the critical angle of the case without the nanoantenna and the uneven structure, and a case where the fluorescence incidence angle was equal to or more than the critical angle of the case without the nanoantenna and the uneven structure. In FIG. 4, the transmission intensity without the recessed portion 18G is indicated as 1.0.

From FIG. 4, in the range of the depth D of the recessed portion 18G of from 10 to 100 nm, the transmission intensity increases by about 10 to 20% compared with the case without the recessed portion 18G in every range of the fluorescence incidence angle.

The fluorescence transmission intensity at equal to or more than the critical angle of the case without the nanoantenna and the uneven structure is lower than the case without the recessed portion 18G when the depth D of the recessed portion 18G exceeds 120 nm. That is, it is seen that to maintain the fluorescence transmission intensity in the range equal to or more than the critical angle of the case without the nanoantenna and the uneven structure to be higher than the case without the recessed portion 18G, the depth D of the recessed portion 18G is preferably 120 nm or less.

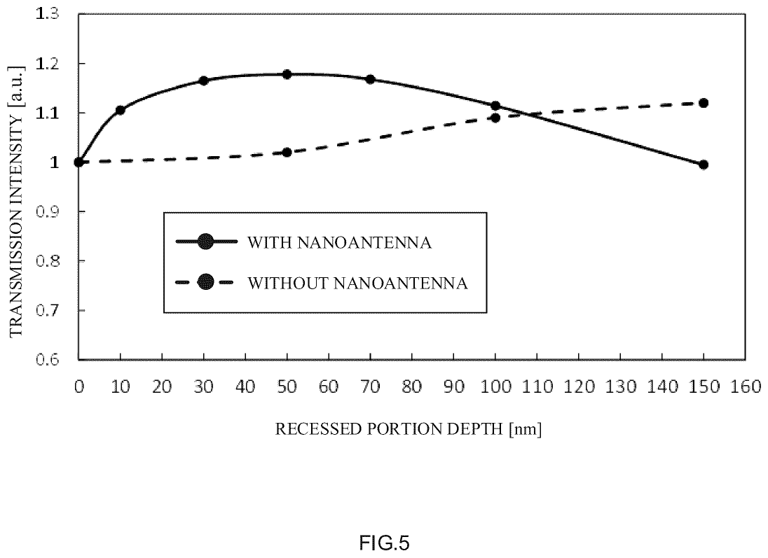

FIG. 5 is a graph illustrating a result of a calculation of the transmission intensity in the case where the incidence angle of the fluorescence when the depth D of the recessed portion 18G is changed is the entire angle range using the RCWA method. In FIG. 5, a change of the transmission intensity depending on whether or not a nanoantenna is provided was verified using the wavelength conversion device 100 and a wavelength conversion device having a configuration without a nanoantenna as a comparison target. In FIG. 5, the transmission intensity without the recessed portion 18G is indicated as 1.0 in each of the models including/without the nanoantenna.

From FIG. 5, the transmission intensity in the case of “without the nanoantenna” increases as the depth D of the recessed portion 18G increases. That is, to increase the transmission intensity of the fluorescence emitted from the phosphor member 18 having the uneven structure, increasing the depth D of the recessed portion 18G is preferred.

However, as described above, when the nanoantenna 21 is formed on the upper surface of the projecting portion 18C (including the nanoantenna), the fluorescence transmission intensity in the range of the incidence angle equal to or more than the critical angle of the case without the nanoantenna and the uneven structure becomes low compared with the case without the uneven structure when the depth D of the recessed portion 18G exceeds 120 nm.

Therefore, to improve the efficiency of light extraction from the phosphor member 18 while using the fluorescence with the incidence angle equal to or more than the critical angle of the case without the nanoantenna and the uneven structure, the depth D of the recessed portion 18G is preferably 120 nm or less.

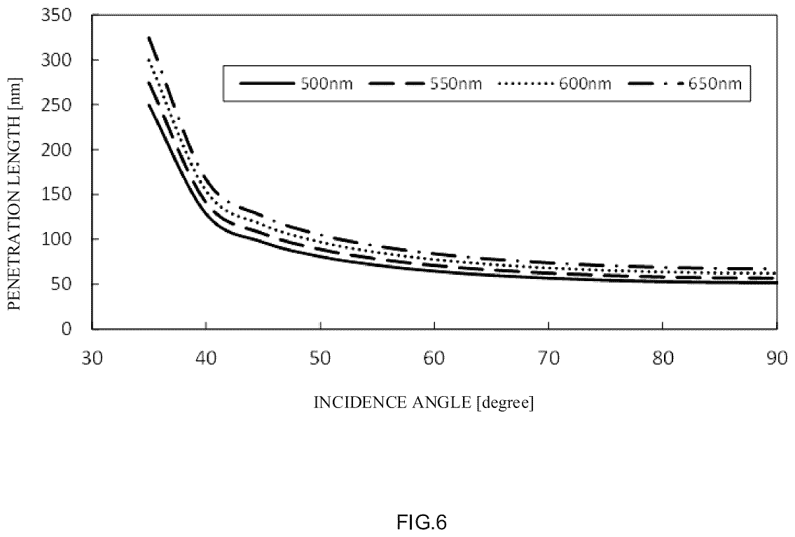

FIG. 6 is a graph illustrating a penetration length of an evanescent wave penetrating from the upper surface of the phosphor member 18 when an intensity becomes from a maximum intensity to a predetermined intensity with respect to the fluorescence incidence angle changed.

FIG. 6 illustrates the penetration length of the evanescent wave generated at the surface of the phosphor member when the intensity becomes from the maximum intensity to the intensity of 1/e for each wavelength of the fluorescence (500 nm, 550 nm, 600 nm, 650 nm). The penetration length d of the evanescent wave is obtained by a formula below.

$$d = \frac{λ}{2 π {n}_{1}} {\{ {sin}^{2} θ - {( \frac{{n}_{2}}{{n}_{1}} )}^{2} \}}^{- 1 / 2} \qquad [ Math . 1 ]$$

Here, a wavelength λ is the wavelength of the fluorescence, a refractive index n₁ is the refractive index of the phosphor member 18, and a refractive index n₂ is the refractive index of air. An incidence angle θ is an angle of incidence of the fluorescence to the interface between the phosphor member 18 and air.

From FIG. 6, in the range of the fluorescence incidence angle up to 40°, the variation of the penetration length d relative to the incidence angle is large, and in the range of the fluorescence incidence angle of from 40 to 89°, the variation of the penetration length d relative to the incidence angle is small.

For example, when the wavelength of the fluorescence is 550 nm, to obtain the evanescent wave having the penetration length d of 150 nm, a fluorescence of a component with the fluorescence incidence angle θ of less than 40° is required. In other words, when the fluorescence incidence angle θ exceeds 40°, the evanescent wave having the penetration length d of 150 nm is less likely to be obtained.

That is, as the depth D of the recessed portion 18G is deepened, the evanescent wave having the penetration length d corresponding to the depth is required, and therefore, the range of the fluorescence incidence angle satisfying the penetration length d is restricted.

Therefore, in FIG. 5, it is considered that when the depth D of the recessed portion 18G is deepened, it becomes difficult for the evanescent wave to penetrate to reach the nanoantenna 21, and this causes the electric field to be less likely to be enhanced, thereby reducing the transmission intensity of the fluorescence.

Accordingly, from the results illustrated in FIG. 3 to FIG. 6, to improve the light extraction efficiency while using the wide angle range of the fluorescence incidence angle, the depth D of the recessed portion 18G in the uneven structure of the phosphor member 18 is preferably 120 nm or less. In other words, the height of the projecting portion 18C from the bottom surface of the recessed portion 18G is preferably 120 nm or less.

### Modification

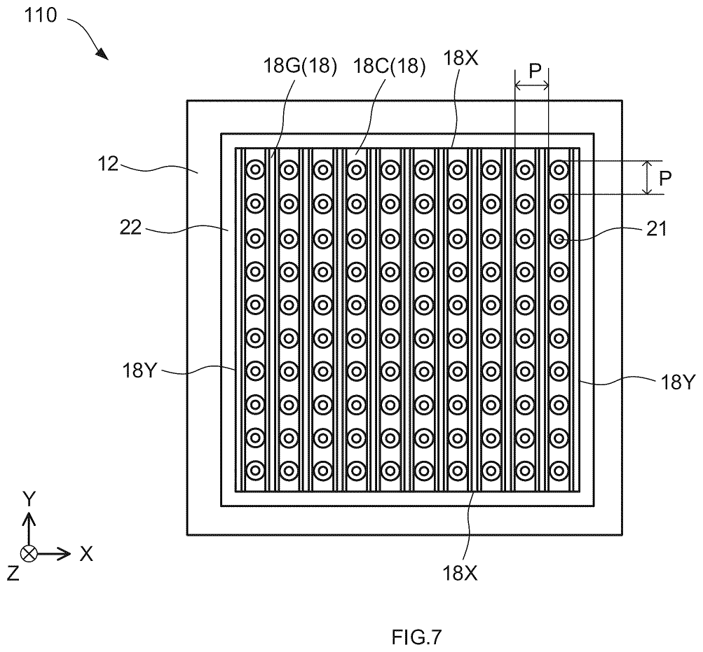

The following describes a modification of the wavelength conversion device 100 according to the first embodiment with reference to FIG. 7. FIG. 7 is a top view of a wavelength conversion device 110 according to the modification. The wavelength conversion device 110 according to the modification is different from the first embodiment in a formation aspect of the uneven structure of the phosphor member 18, and is otherwise similar to the first embodiment, for example, in the configuration of the light-emitting element 13 and the arrangement pitch of the nanoantenna 21.

In this modification, the phosphor member 18 has an uneven structure including a plurality of recesses and projections extending from one side 18X to the other side 18X in the direction along the side 18Y in top view. That is, the uneven structure of the phosphor member 18 forms a striped pattern in which a plurality of projecting portions 18C and recessed portions 18G are provided in the direction along the side 18Y.

In this modification, the respective nanoantennas 21 are disposed on the respective upper surfaces of the projecting portions 18C along the extending direction of the projecting portion 18C at mutually same pitch P. That is, in this modification, in an area excluding the areas in which the respective nanoantennas 21 are formed, the upper surface of the projecting portion 18C is exposed.

The wavelength conversion device 110 having such a configuration can provide the effect similar to that of the first embodiment as well. That is, the component equal to or more than the fluorescence critical angle of the phosphor member 18 can be reduced, and the component totally reflected by the interface between the phosphor member 18 and air can be reduced.

Therefore, the proportion of the fluorescence extracted from the phosphor member 18 can be increased. Accordingly, the light extraction efficiency can be improved while achieving the narrowed angle of the fluorescence with the nanoantenna 21.

### Second Embodiment

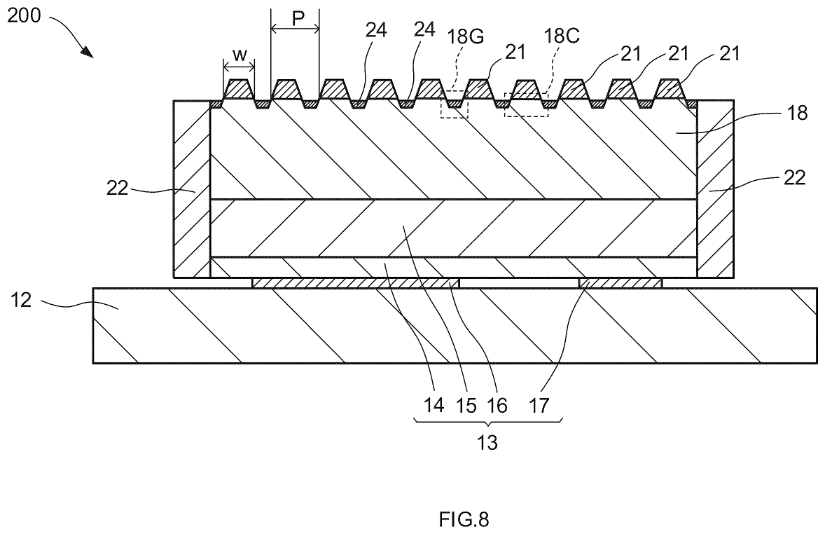

Next, the second embodiment is described with reference to FIG. 8. FIG. 8 is a cross-sectional view of a wavelength conversion device 200 according to the second embodiment. The wavelength conversion device 200 is different from the first embodiment in that a translucent member 24 is provided, and is otherwise similar to the first embodiment, for example, in the configuration of the light-emitting element 13 and the formation aspect of the uneven structure of the phosphor member 18.

The translucent member 24 is, as illustrated in FIG. 8, a member filled in the recessed portion 18G up to a height approximately uniform with the upper surface of the projecting portion 18C in the uneven structure of the phosphor member 18. In other words, the translucent member 24 fills the recessed portions 18G in a manner in which the respective upper surfaces of the projecting portions 18C in the uneven structure are exposed.

The translucent member 24 is made of a material having translucency to the emitted light (blue light) from the light-emitting element 13 and the fluorescence (yellow light) generated in the phosphor member 18 and having a refractive index smaller than that of the phosphor member 18. The translucent member 24 is made of, for example, silicon dioxide (SiO₂ (refractive index n=1.46)) or Al₂O₃ (refractive index n=1.63).

According to the embodiment, since the translucent member 24 having the refractive index smaller than that of the phosphor member 18 is filled in the recessed portion 18G of the phosphor member 18, the behavior of variation of the refractive index when the fluorescence reaches the uneven structure becomes more gradual.

That is, by filling the translucent member 24 in the recessed portion 18G of the phosphor member 18, the critical angle of the fluorescence to the interface between the phosphor member 18 and air at the upper surface of the phosphor member 18 becomes large compared with the first embodiment, thus causing the total reflection to be less likely to occur. Accordingly, the component of equal to or more than the fluorescence critical angle of the phosphor member 18 can be reduced compared with the first embodiment, and the component totally reflected by the interface between the phosphor member 18 and air can be reduced.

Therefore, according to the embodiment, a proportion of the fluorescence extracted from each of the upper surfaces of the projecting portions 18C of the phosphor member 18 can be increased. That is, the light extraction efficiency can be improved while achieving the narrowed angle of the fluorescence with the nanoantenna 21.

The translucent member 24 is preferably filled in the recessed portion 18G up to the height not in direct contact with the nanoantenna 21. This is because the translucent member 24 in contact with the nanoantenna 21 reduces the sensitivity of the nanoantenna 21 to the evanescent wave, thus reducing the action of enhancing the fluorescence. Therefore, the translucent member 24 is preferably filled in the recessed portion 18G, for example, to be lower than the upper surface of the projecting portion 18C by a predetermined height.

### [Method for Manufacturing Phosphor Member]

Here, a method for manufacturing the phosphor member 18 in which the translucent member 24 is formed according to the second embodiment is described. Since the process up to the step of forming the recessed portion at the phosphor member by the etching (Step 3) is similar to the first embodiment, the explanation is omitted.

First, on the uneven structure of the phosphor member formed by the patterning similarly to the first embodiment, a transparent dielectric film made of SiO₂ or Al₂O₃ is formed by an electron beam evaporation or a sputtering film formation (Step 4A). Thus, the translucent member is formed over the upper surface of the phosphor member.

Next, the translucent member formed on the etching mask (resist) of the respective projecting portions 18C is removed together with the etching mask by a lift-off process (Step 5). Thus, the phosphor member 18 in which the translucent member 24 is filled in the recessed portion 18G can be obtained.

The above-described configuration in which the translucent member 24 is filled in the recessed portion 18G may be applied to the configuration of the above-described modification. That is, a configuration in which the translucent member 24 is filled in each of the plurality of recessed portions 18G formed in the striped pattern may be applied.

### Third Embodiment

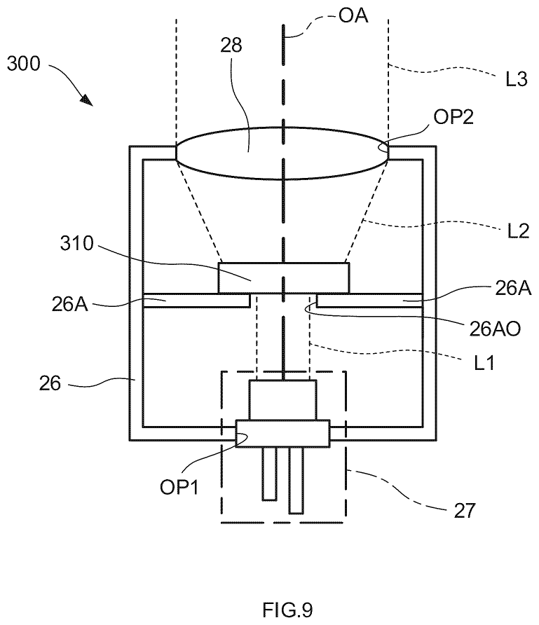

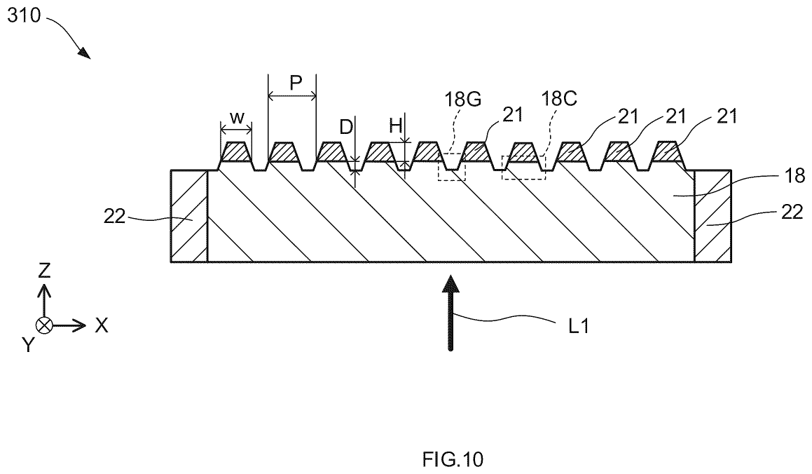

Next, the third embodiment is described with reference to FIG. 9 and FIG. 10. FIG. 9 is a cross-sectional view schematically illustrating a configuration of an illumination device 300 according to the third embodiment. FIG. 10 is a cross-sectional view of a wavelength conversion device 310. In FIG. 9, hatching is omitted in consideration of the visibility.

A casing 26 is a box-shaped casing provided with opening portions OP1 and OP2 at respective two surfaces facing to one another. The casing 26 is provided with a support structure 26A for supporting an object at a position between the opening portion OP1 and the opening portion OP2. The support structure 26A is provided with a through hole 26AO penetrating the support structure 26A at the center thereof.

A light source 27 is a light source that is secured in the opening portion OP1 and emits a light L1 having a predetermined wavelength toward the opening portion OP2. The opening portion OP1, the through hole 26AO, and the opening portion OP2 are formed on an optical axis OA.

In this embodiment, the light source 27 is a laser light source with a light-emitting layer made of an InGaN-based semiconductor. The light source 27 emits a blue light having a peak wavelength of about 450 nm as the light L1.

The wavelength conversion device 310 is supported by the support structure 26A to be located on the optical axis OA. Specifically, the wavelength conversion device 310 is disposed on the upper surface of the support structure 26A in a manner in which a center portion of a bottom surface through which the optical axis OA passes is exposed from the through hole 26AO of the support structure 26A. In other words, in the wavelength conversion device 310, an area excluding the center of the bottom surface of the wavelength conversion device 310 is supported by the support structure 26A.

The wavelength conversion device 310 includes, as illustrated in FIG. 10, the phosphor member 18, the nanoantennas 21 formed on the respective upper surfaces of the projecting portions 18C of the phosphor member 18, and the light reflecting member 22 formed on the side surface of the phosphor member 18, which are illustrated in FIG. 2. In other words, the wavelength conversion device 310 has a configuration in which the mounting substrate 12 and the light-emitting element 13 are removed from the configuration of the wavelength conversion device 100 in the first embodiment.

The wavelength conversion device 310 is, similarly to the first embodiment, excited by an excitation light (blue light) having the peak wavelength of 450 nm to emit a fluorescence (yellow light) having the peak wavelength of 550 nm. Therefore, the wavelength conversion device 310 emits the excitation light (blue light) that has passed through the phosphor member 18 without a contribution to the generation of the fluorescence and the fluorescence (yellow light) emitted from the phosphor. FIG. 9 illustrates the excitation light and the fluorescence emitted from the wavelength conversion device 310 together as a light L2.

A transparent support substrate made of, for example, single crystal sapphire, having a high thermal conductivity may be provided between the wavelength conversion device 310 and the support structure 26A. Providing the transparent support substrate allows efficiently transmitting a heat generated at the wavelength conversion device 310 to the support structure 26A.

A lens that collects a laser light may be provided between the light source 27 and an incidence plane of the light L1 of the wavelength conversion device 310. Providing the lens allows collecting the laser light to efficiently irradiate the wavelength conversion device 310 with the laser light.

A lens 28 is an optical member secured in the opening portion OP2. That is, the lens 28 is located on the optical axis OA. The lens 28 is an optical lens that receives the light L2 emitted from the wavelength conversion device 310 and forms the light L2 in a desired light distribution to generate a light L3 as an illumination light. For the lens 28, for example, a spherical lens and an aspherical lens can be used. The light L3 generated by the lens 28 is extracted outside the casing 26.

In this embodiment, a space between the light source 27 and the wavelength conversion device 310 and a space between the wavelength conversion device 310 and the lens 28 in the casing 26 are filled with air. That is, the light L2 emitted from the wavelength conversion device 310 is incident on the lens 28 passing through the air.

The illumination device 300 having the configuration as described above can provide the effect similar to that of the first embodiment as well. That is, the component equal to or more than the fluorescence critical angle of the phosphor member 18 can be reduced, and the component totally reflected by the interface between the phosphor member 18 and air can be reduced.

Therefore, the proportion of the fluorescence extracted from the phosphor member 18 can be increased. Accordingly, the light extraction efficiency can be improved while achieving the narrowed angle of the fluorescence with the nanoantenna 21.

While the case where the phosphor member 18 is made of a single crystal YAG:Ce phosphor plate is described in the embodiments and the modification described above, the configuration of the phosphor member 18 is not limited to this, and the phosphor member 18 only needs to have a configuration in which light scattering is less likely to occur inside. As a configuration in which the scattering is less likely to occur, a single-phase phosphor plate made of single material is preferable, and in this case, polycrystal may be used. For example, a plate having a medium of resin or glass containing phosphor particles that emit a yellow fluorescence may be used.

While the case where the respective projecting portions 18C in the uneven structure of the phosphor member 18 are arranged in a square grid pattern on the upper surface of the phosphor member 18 is described in the embodiments and the modification described above, it is not limited to this. For example, the respective projecting portions 18C may be arranged in a triangular grid pattern on the upper surface of the phosphor member 18.

While the case where the nanoantenna 21 has the circular truncated cone shape is described in the embodiments and the modification described above, the shape is not limited to this, and it is only necessary that the nanoantenna 21 can provide the action of narrowing the angle of the fluorescence. For example, the nanoantenna 21 may have a pillar shape, such as a columnar shape, or a cone shape, such as a circular cone shape.

While the case where the light reflecting member 22 is provided is described in the embodiments and the modification described above, the light reflecting member 22 does not need to be provided depending on the required light distribution. An optical multilayer reflective film or a metal reflective film may be used instead of the light reflecting member 22 depending on the required light distribution, or a combination thereof may be provided on the side surfaces of the light-emitting element 13 and the phosphor member 18.

### DESCRIPTION OF REFERENCE SIGNS

100, 110, 200, 310 Wavelength conversion device
300 Illumination device
12 Mounting substrate
13 Light-emitting element
14 Semiconductor structure layer
15 Support substrate
16 p-electrode
17 n-electrode
18 Phosphor member
21 Nanoantenna
22 Light reflecting member
24 Translucent member
26 Casing
27 Light source (laser light source)
28 Lens

1. A wavelength conversion device comprising:
a phosphor member that has one surface on which an excitation light is incident, includes a phosphor excited by the excitation light to emit a fluorescence, and has an uneven structure on another surface in an opposite side of the one surface, the uneven structure including a plurality of projecting portions each provided in one direction along the other surface at a pitch smaller than a peak wavelength of the fluorescence; and
a plurality of nanoantennas provided at upper surfaces of the plurality of projecting portions and made of a metal material.

2. The wavelength conversion device according to claim 1, wherein
the uneven structure forms an arrangement pattern of a square grid pattern or a triangular grid pattern, and
the plurality of nanoantennas are provided on the respective upper surfaces of the plurality of projecting portions.

3. The wavelength conversion device according to claim 1, wherein
the uneven structure forms a striped pattern arranged in the one direction, and
the plurality of nanoantennas are arranged at the plurality of respective projecting portions along an extending direction of the plurality of projecting portions.

4. The wavelength conversion device according to claim 1, comprising
a translucent member that fills a recessed portion of the uneven structure, has a small refractive index compared with the phosphor member, and has a translucency to the excitation light and the fluorescence.

5. The wavelength conversion device according to claim 1, wherein
the phosphor has a property of being excited by the excitation light to emit the fluorescence having the peak wavelength of 520 to 570 nm, and
each of the plurality of projecting portions has a height of 120 nm or less.

6. The wavelength conversion device according to claim 1, wherein
the phosphor member is made of a single-phase phosphor plate.

7. The wavelength conversion device according to claim 1, wherein
the plurality of nanoantennas are formed in a pillar shape, a cone shape, or a truncated pyramid shape.

8. The wavelength conversion device according to claim 1, wherein
the plurality of nanoantennas are made of Al or Ag.

9. An illumination device comprising:
the wavelength conversion device according to claim 1; and
a light source that emits the excitation light toward the one surface of the phosphor member.
